(19) United States
(12) Patent Application Publication
(10) Pub. No.: US 2023/0382155 A1
(43) Pub. Date: Nov. 30, 2023

(54) Paint Tray

(71) Applicant: Christian Sassani, Philadelphia, PA (US)

(72) Inventor: Christian Sassani, Philadelphia, PA (US)

(73) Assignee: Christian Sassani, Philadelphia, PA (US)

(21) Appl. No.: 17/962,199

(22) Filed: Oct. 7, 2022

Related U.S. Application Data
(63) Continuation-in-part of application No. 29/840,638, filed on May 31, 2022.

(51) Int. Cl. B44D 3/12

(52) U.S. Cl. CPC B44D 3/126; B44D 3/128

(57) ABSTRACT

The paint tray device may include an open circle structure and a tray structure. The open circle structure may fully encircle the rim of an upper circumference of an open paint container. The open circle structure may have a top side and a bottom side. The top side may fully cover the rim of the open paint container. The bottom side may have a void configured to engage the rim of the open paint container via an annular snap-fit. The tray structure may extend from an edge of the open circle structure. The tray structure may extend at an incline and may have an upper surface with ridges such that excess paint removed from a paint roller in the tray may flow into the open paint container at the edge from which the tray structure extends.

### CROSS-REFERENCE TO RELATED APPLICATIONS

The present application is a continuation-in-part of and claims the benefit of U.S. Design Patent Application 29/840,638, entitled “Paint Tray”, and filed on May 31, 2022, the contents of which are hereby incorporated by reference in their entirety.

### BACKGROUND

Everyone paints. Unlike electrical work, carpentry, appliance installation, etc., painting is an accessible home improvement activity. A stroll in the paint aisle of any local hardware store on a Saturday morning will have you find a drove of enthusiastic do-it-yourselfers (DIY'ers) selecting the perfect color, brush, and accessories for their projects. During the week, work vans and ladder trucks crisscross our towns from one job site to another. The U.S. Bureau of Labor Statistics states that there are over 200,000 employed painters in the United States, who apply paint to walls, equipment, buildings, bridges and other structural surfaces (Occupational Employment and Wages, May 2021, 47-2141 Painters, Construction and Maintenance). The act of applying a pigment to a surface has been part human life since before civilization-there are few other activities so widely performed today that could assert the same.

And although technical advances in painting materials have led to more resilient surfaces, better adhesion, and longer lasting colors, the physical labor of getting liquid paint from a container to a surface, has changed very little in modern times. It remains a manual and somewhat messy process of pouring from a storage container to a working container, loading a paint brush, roller, or sprayer, and ultimately applying one or more coats, where every physical movement is fraught with drips and spills.

### SUMMARY

This patent application discloses a significant improvement to the art. The device disclosed herein, e.g., a drip-preventing paint tray, may allow anyone to get paint from an original container loaded and spread while minimizing risk of drips and spills.

The device may snap-on to the upper rim of an open paint container, e.g., the manufacturer's original can. The device may provide an integrated, sturdy tray for loading paint onto an applicator, such as paint roller. And the tray itself may remain clear of the paint can handle, so as unit, the paint can and attached tray together may be easily carried to the surface to be painted.

The device may cover the upper rim of the paint can, and with the integrated tray adjacent, any excess paint from loading the applicator, including drips, deposits into the tray and flows down an incline, over the portion covering the paint can's rim, and back into the paint can itself. Paint does not get down into the upper groove in can's rim, so replacing the paint can lid is less messy. And without paint in that upper groove, the paint can lid itself does not later become stuck to the can.

The device may include an open circle structure and a tray structure. The open circle structure may fully encircle the rim of an upper circumference of an open paint container. The open circle structure may have an opening to the interior of the paint can. The opening may be suitable for dipping a paint applicator, e.g., a four-inch paint roller, into the paint inside the can, e.g., an industry gallon paint can.

The open circle structure may have a top side and a bottom side. The top side may fully cover the rim of the open paint container. The bottom side may have a void configured to engage the rim of the open paint container via an annular snap-fit.

The tray structure may extend from an edge of the open circle structure. The tray structure may extend at an incline relative to a plane defined by the top side of the open circle structure. The tray structure may have an upper surface with ridges to remove excess paint from an applicator such as a paint roller. The upper surface may be open for paint to flow from the tray structure into the open paint container at the edge from which the tray structure extends from the open circle structure.

### BRIEF DESCRIPTION OF THE DRAWINGS

FIG. 1 is perspective view of an example drip-preventing paint tray device in use with a roller brush and paint can.

FIG. 2 is perspective view of an example drip-preventing paint tray device.

FIG. 3 is top view of an example drip-preventing paint tray device.

FIG. 4 is bottom view of an example drip-preventing paint tray device.

FIG. 5 is front view of an example drip-preventing paint tray device.

FIG. 6 is rear view of an example drip-preventing paint tray device.

FIG. 7 is left-side view of an example drip-preventing paint tray device.

FIG. 8 is right-side view of an example drip-preventing paint tray device.

FIG. 9 depicts a cross-section of an example snap-on rim portion of an example drip-preventing paint tray device.

### DETAILED DESCRIPTION

Paint may be transported to a worksite from a store or manufacturer in a primary container, such as a can, bucket, drum, or intermediate bulk container (IBC), for example. And traditionally, paint may be poured from its primary container to secondary container, such as a stand-alone paint tray, smaller bucket, or the like, at the worksite. Pouring paint from its primary container often results in drips, especially down the outside of the container, and, when the primary container is an industry paint can, residual paint in the container's lid groove.

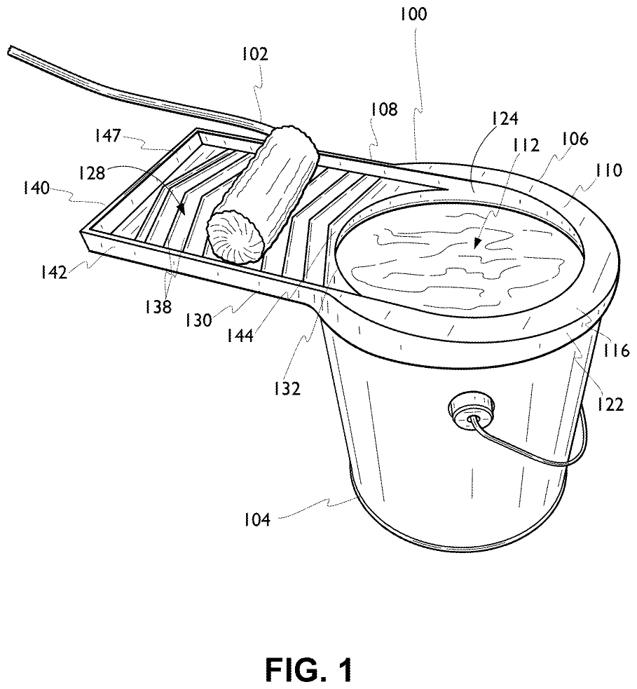

Here, FIG. 1 shows an example drip-preventing paint tray device. The device 100 is shown in use with a paint roller 102 and an open paint container 104. For example, the device 100 may be a paint tray device (such as a drip-preventing pain tray device). The device 100 may be removably attachable to the open paint container 104.

The device 100 may be used with any suitable open paint container 104. For example, the open paint container 104 may be an open paint can, such as an industry gallon paint can. For example, the open paint container 104 may be an open paint can, such as an industry pint paint can, an industry quart paint can, an intermediate-size paint can, or the like. For example, the open paint container 104 may be a bucket and/or pail for containing paint, such as an industry five-gallon paint bucket. For example, the open paint container 104 may be an open paint drum.

The open paint container 104 may be made of any material suitable for containing paint, such as plastic, metal, and/or a combination of plastic and metal. For example, the open paint container 104 may be a tin-coated steel paint container. The open paint container 104 may be lined, with epoxy for example, or unlined. For example, the open paint container 104 may be a five-gallon steel pail. For example, the open paint container 104 may be a polypropylene paint container. For example, the open paint container 104 may be a high-density polypropylene (HDPE) paint container. For example, the open paint container 104 may be a plastic pail.

The open paint container 104 may include a handle, as shown for example. The open paint container 104 may be without a handle. The open paint container 104 may have a corresponding lid (not shown). The lid may be secured to the open paint container 104 with any suitable closing mechanism, including a screw lid, a friction fit, paint can clips, a paint can overseal, or the like. The lid may be secured to the open paint container 104 as a plastic pry-off pail lid, a shipping pail lid, a snaplock pail lid, or the like.

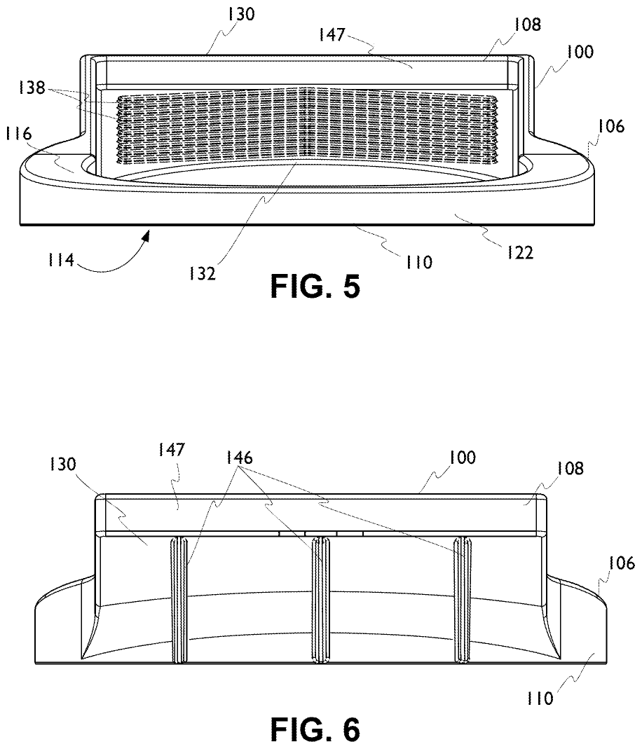

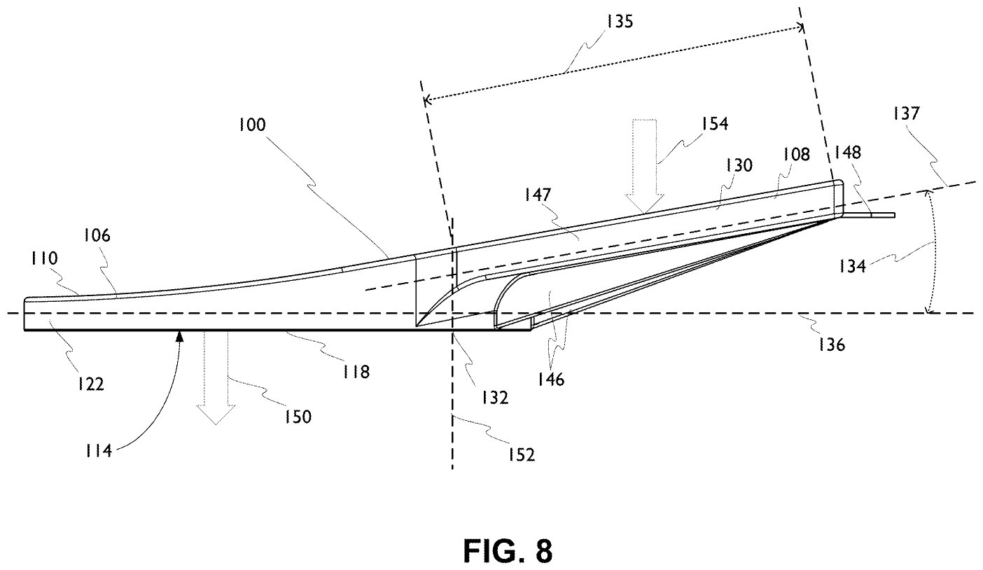

As shown in FIGS. 1-9, the device may include a first portion 106 and a second portion 108. The first portion 106 may be configured to encircle the upper circumference of the open paint container 104. The first portion 106 may include an open circle structure 110. The open circle structure 110 may have an opening 112 to the interior of the open paint container 104. The opening 112 may be suitable for dipping a paint applicator, e.g., paint roller 102, a paint brush, or the like. In an example, the opening 112 may be suitable for dipping a four-inch paint roller into the paint inside an industry gallon paint can. In an example, the opening 112 may be suitable for dipping a three-inch paint roller into the paint inside an industry gallon paint can. In an example, the opening 112 may be suitable for dipping a nine-inch paint roller into the paint inside an industry five-gallon paint container.

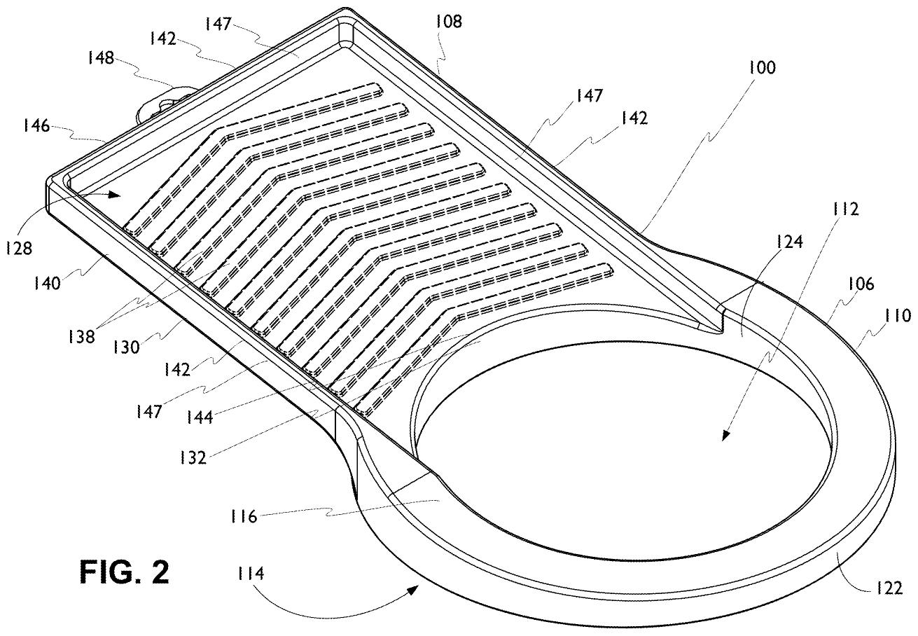

The first portion 106 may be configured to be removably attachable to the open paint container 104. For example, the first portion 106 may be configured to be removably attachable to a rim of the upper circumference of the open paint container 104. As shown e.g., in FIG. 2, the open circle structure 110 may have bottom side 114 and a top side 116.

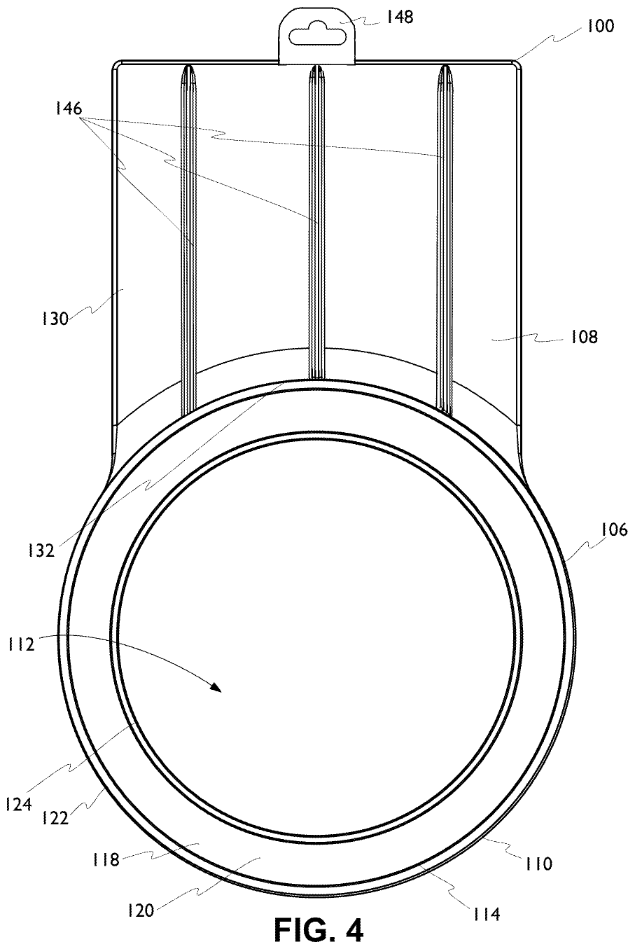

The bottom side 114 may be configured to engage rim of the upper circumference of the open paint container 104. The bottom side 114 may be configured with any mechanism suitable for engaging the rim of the upper circumference of the open paint container 104. For example, as shown in FIG. 4, the bottom side 114 of the open circle structure 110 may include, for example, a void 120. And the void 120 may be configured to engage the rim of the upper circumference of the open paint container 104. For example, the void 120 may have a width and a depth suitable to receive the rim of the upper circumference of the paint can.

As shown in FIG. 4, e.g., the void 120 may be defined between an outer wall 122 of the open circle structure 110 and an inner wall 124 of the open circle structure 110. The outer wall 122 may be circular. The inner wall 124 may be circular. The outer wall 122 and the inner wall 124 may be concentric. The inner wall 124 may define the opening 112 of the open circle structure 110. The void 120 may run concentrically with the open circle structure 110. The void 120 (and, for example, the open circle structure 110) may be configured to fully encircle the rim of the upper circumference of the open paint container 104.

In an example, the device 100 may include a snap-fit mechanism. The snap-fit mechanism may be suitable for snapping the first portion 106 of the device 100 to the rim of the upper circumference of the open paint container 104. For example, the snap-fit mechanism may be suitable for snapping the open circle structure 110 to the rim of the upper circumference of the open paint container 104.

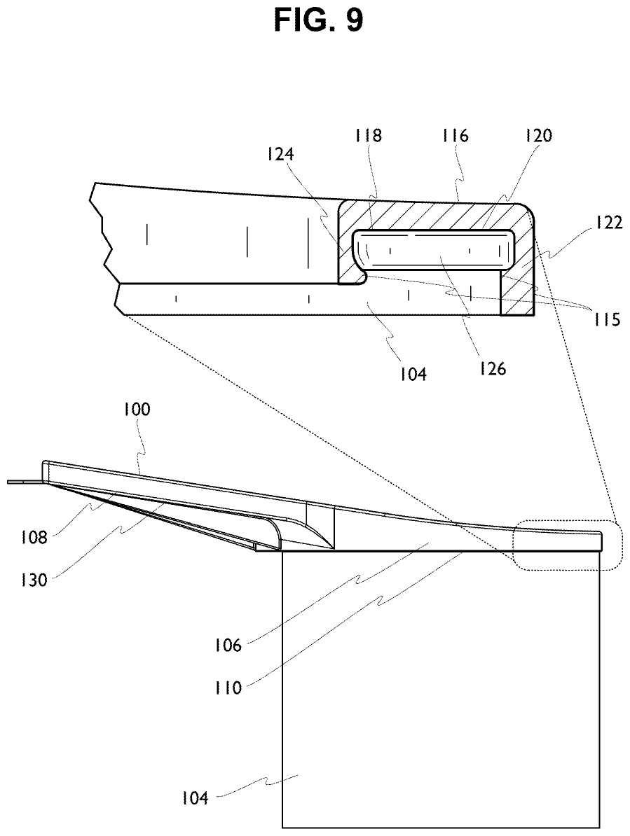

For example, and as illustrated in FIG. 9, e.g., the snap-fit mechanism may be an annular snap-fit mechanism 118. The annular snap-fit mechanism 118 may, for example, utilize hoop-strain to engage the profile of the rim (such as example rim profile 126 of FIG. 9) of the upper circumference of the open paint container 104 between the inner wall 124 and the outer wall 122. The expansion of the circumference associated with the void 120 may provide hoop-strain to the rim of the open paint container 104. In an example, the open circle structure 110 may be made of a material and the walls of the void may be sized such that it is more elastic than the rigid rim of the open paint container 104.

Industry paint cans have a broad tolerance rim width and diameter. An annular snap-fit mechanism 118 for an industry paint can may balance strength and compatibility with selections of dimensions and materials. For example, an annular snap-fit mechanism 118 for an industry gallon paint can may include an inner diameter and an outer diameter for effective hoop-strain with for example, a Shore A hardness material, such as a thermoplastic, resin, or the like. The inner diameter may range, for example, from 5.4″ to 5.452″. In an example, the inner diameter may be 5.436″. The outer diameter may range, for example, from 6.219″ to 6.563″. In an example, the outer diameter may be 6.531″.

In an example, the snap-fit mechanism may be a cantilever snap-fit mechanism. For example, the open circle structure 110, e.g., the bottom side 114, may be include one or more cantilevers. Each cantilever may include a respective downwardly extending member with a corresponding distal latch, for example. The one or more cantilevers may be configured to deflect when pressing the open circle structure 110 onto the rim of the open paint container 104. The one or more cantilevers may be oriented to deflect and latch inwardly, outwardly, and/or a combination of inwardly and outwardly. In an example, one or more cantilevers may be arranged in inwardly deflecting and outwardly deflecting pairs.

The top side 116 may be configured to fully cover the upper rim of the upper circumference of the open paint container 104. For example, the top side 116 of the open circle structure 110 may prevent paint from dripping into any cavity within the upper rim of the open paint container 104. This top side 116 may prevent paint from entering the upper ridges of the open paint container 104, that may encumber later resealing of the open paint container 104 with the paint can lid. The top side 116 of the open circle structure 110, having prevented paint from dripping into the upper rim of the open paint container 104, may prevent a paint container lid from being stuck or adhered to the paint container by way of dried paint, for example. The device 100 may comprise a second portion 108. The second portion 108 may extend from the first portion 106. The second portion 108 may be configured to remove excess paint from a paint roller for example.

The first portion 106 may be configured to be configured to protect the rim of the upper circumference of the open paint container 104 from paint. For example, the first portion 106 may be configured to fully cover and encircle the rim of the upper circumference of the open paint container 104. For example, the as shown e.g., in FIG. 2, the top side 116, outer wall 122, and inner wall 124 may serve to shield (e.g., as covering structure, transition structure, and/or a combination of covering structure and transition structure) the rim of the upper circumference of the open paint container 104 from paint. For example, at least some of the top side 116, outer wall 122, and inner wall 124 may be a covering structure, such that the top side 116 covers the rim of the upper circumference of the open paint container 104. For example, at least some of the top side 116, outer wall 122, and inner wall 124 may be a transition structure to the upper surface 128 of the tray structure 130 of the second portion 108 of the device 100.

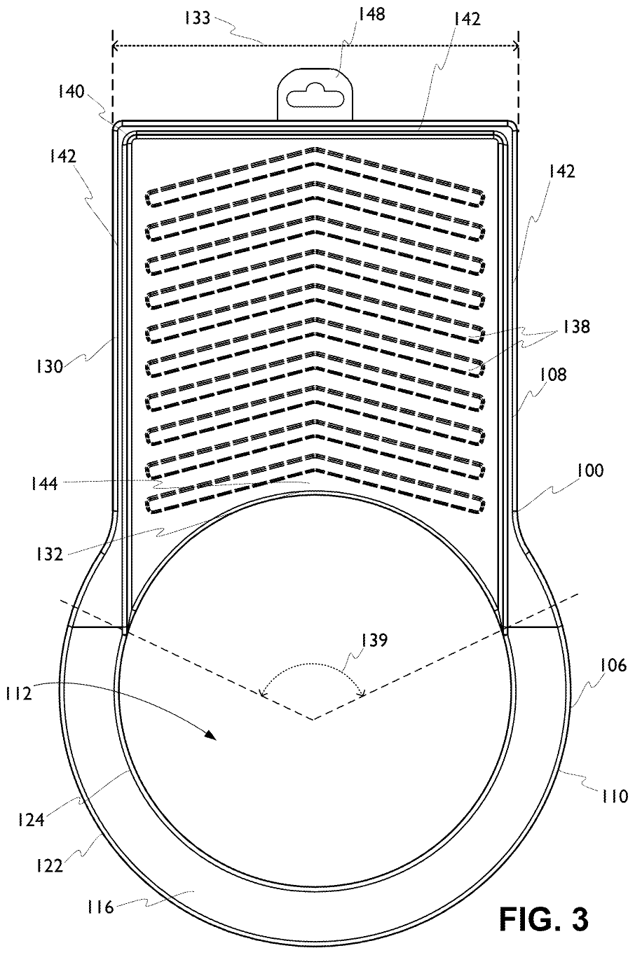

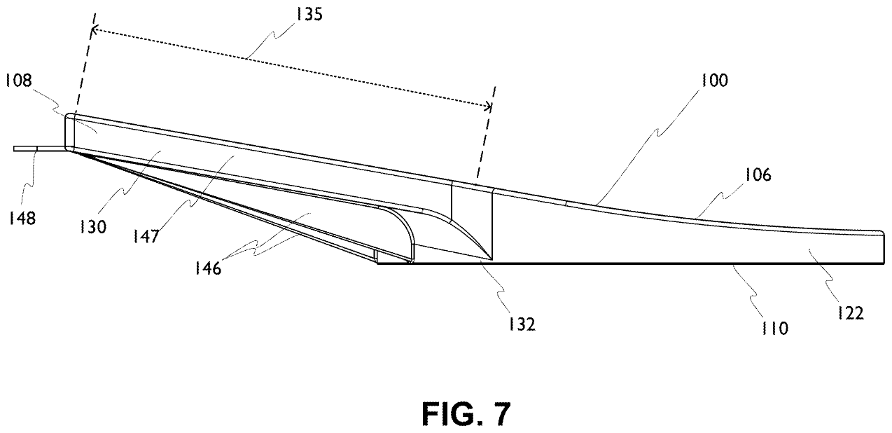

The device 100 may provide an integrated, sturdy tray structure 130 for loading paint onto an applicator, such as paint roller. The second portion 108 of the device 100 may include a tray structure 130. The tray structure 130 may extend from an edge 132 of the open circle structure 110. For example, the tray structure 130 may be configured in a generally longitudinal, rectangular shape with a first longitudinal end is proximate to the open circle structure 110 and the opposite end being distal to the open circle structure 110. The tray structure 130 may define a width 133 (as shown in FIG. 3, e.g.) and a length 135 (as shown in FIG. 7, e.g.).

The tray structure may be any size suitable for loading the paint applicator, removing excess paint from the paint applicator, and/or being clear of a handle of the open paint container 104. For example, a tray structure 130 with an about five inch (e.g., five inch) width 133, an about five inch (e.g., five inch) length 135 (i.e., about five inches length measured from the center of the distal end to the center of edge 132, about 7.5 inches measured from center of the distal end to the center of the opening 112, for an industry gallon paint container) may remain clear of the handle of an industry gallon paint container.

The tray structure 130 may be integrated with the open circle structure 110. For example, the tray structure may have continuous material from the upper surface 128 of the tray structure 130 and the inner wall 124 of the open circle structure 110. The tray structure may have a width, coextensive with the edge 132. For example, and as shown in FIG. 3, e.g., the edge 132 may represented by an arc 139 of the open circle structure 110.

The tray structure 130 may be oriented relative to the open circle structure 110. The tray structure 130 may be oriented at an incline 134 relative to the open circle structure 110. The incline may be a suitable incline for stability, human factors, and/or to enable gravity-fed flow of paint from the tray structure 130 to the open circle structure 110.

For example, as illustrated in FIG. 7, the open circle structure may define a plane 136. For example, the plane 136 may be defined to be parallel relative to the bottom side 114 of the open circle structure 110, parallel relative to the top side 116 of the open circle structure 110, orthogonal to a longitudinal direction of the inner wall 124 and/or outer wall 122, for example. For example, the plane 136 may be defined to be parallel relative to opening of the open paint container 104. The incline 134 of the tray structure 130 may be defined, for example, by the upper surface 128 of the tray structure. For example, the upper surface 128 of the tray structure may define a plane 137. The incline 134 may be defined relative to the plane 136 defined by the bottom side 114 of the open circle structure 110 and the plane 137 defined by upper surface 128 of the tray structure 130. In an example, the incline 134 may be a 10-20 degree incline. In an example, with an open circle structure suitable for an industry gallon paint can, the incline 134 may be a 15 degree incline.

The tray structure 130 may be suitable for loading a paint applicator. For example, the tray structure 130 may be suitable for loading a paint brush. For example, the tray structure 130 may be suitable for loading a paint roller. For example, the tray structure 130 may be suitable for use with a four-inch roller frame (e.g., loading paint onto a four-inch paint roller). For example, the tray structure 130 may be suitable for use with a three-inch roller frame (e.g., loading paint onto a three-inch paint roller). For example, the tray structure 13 may be suitable for use with a nine-inch roller frame (e.g., loading paint onto a nine-inch paint roller). The tray structure 130 may one or more ridges 138. The ridges 138 may be suitable for removing excess paint from a paint applicator. For example, the ridges 138 may be suitable for removing excess paint from paint roller. The upper surface 128 of the tray structure 130 may include the ridges 138. The ridges 138 may be oriented in a chevron pattern, for example.

The tray structure 130 may have a perimeter 140. The perimeter 140 include a first extent 142 of the perimeter 140 and a second extent 144 of the perimeter 140. The first extent 142 of the perimeter may include two longitudinal sides of the tray structure 130 and the lateral side of the tray structure that is distal to the open circle structure 110. The first extent 142 of the perimeter 140 may be walled. The wall 147 may form the basin of the tray structure. For example, the wall 147 may extend orthogonally from the upper surface 128 of the tray structure 130. The wall 147 may be of suitable height to prevent paint (e.g., excess paint from a paint roller) from flowing over the wall 147.

The tray structure 130 may include a portion that is open for paint flow (e.g., open for paint to flow from the tray and into the open paint container). For example, the second extent 144 of the perimeter 140 may include one lateral side, proximate to the open circle structure 110, of the tray structure 130. The second extent 144 of the perimeter 140 may be open (e.g., non-walled, e.g., suitable for paint to flow from the tray structure 130, over a portion of the open circle structure 110, and into the open paint container 104). The second extent 144 of the perimeter 140 may be coextensive with the edge 132 from which the tray structure 130 extends from the open circle structure 110.

The tray structure 130 may be stiffened and/or supported by one or more supporting structures. The support structures may include any structure or material selection to stiffen and/or support the tray structure 130. For example, the supports may include one or more support ridges 146. One or more support ridges 146 may be located on the bottom side (e.g., the bottom surface) of the tray structure. One or more support ridges 146 may be longitudinal relative to the tray structure 130. For example, one or more support ridges 146 may extend from the outer wall of the open circle structure. For example, one or more support ridges 146 may extend from the outer wall 122 of the open circle structure along the bottom side of the tray structure 130.

The length 135 of the tray structure 130 may have relation to the configuration of the snap-fit mechanism of the open circle structure 110. For example, the removal force (e.g., the minimum force needed to remove the device 100 from the open paint container 104) of the snap-fit mechanism, such as the annular snap-fit mechanism 118 for example, may represent a first torque (e.g., a first force 150 relative to pivot 152) relative to the edge 132 of the open circle structure 110 from which the tray structure 130 extends. The paint applicator force (e.g., the position and magnitude or the force applied to the tray structure when removing excess paint from a paint roller, for example) may represent a second torque (e.g., a second force 154 relative to pivot 152) relative to the edge 132 of the open circle structure 110. The first torque may be greater than the second torque. In operation, having a sufficient torque first torque relative to the expected second torque may prevent the inadvertent separation of the open circle structure 110 (and e.g., the device 100) from the open paint container 104.

The device 100 may be manufactured from any material and/or combination of materials suitable for a light industrial application. For example, the material and/or combination of materials include polymers, such as a flexible thermoformable polymer, resins, metals, and the like. The device 100 may be manufactured according to any suitable manufacturing process for the selected material and/or combination of materials. For example, the device 100 (e.g., the first portion 106 and/or the second portion 108) may be manufactured by plastic molding. For example, the device 100 (e.g., the first portion 106 and/or the second portion 108) may be manufactured according to an injection molding process. For example, one may perform injection molding of a plastic part that reflects the shape, size, and properties of the device 100 disclosed herein. The device 100 (e.g., the first portion 106 and/or the second portion 108) may be manufactured by machining, e.g., metal machining.

The device 100 may be manufactured according to an additive manufacturing process, such as 3D printing. A method of manufacturing the device 100 may include uploading, downloading, and/or making available for download, a digital file than when put to an additive manufacturing process, such as a home-use and/or industrial use 3D printer, results in the device 100.

The device 100 may include a retail hanger (such as hanger 148). The retail hanger may include any structure suitable from which to hanging and/or display the device 100 in a retail environment (such as from a peg board display for example). The retail hanger, such as hanger 148 for example, may be made of plastic, integral to the device 100.

1. A drip-preventing, snap-on paint tray, comprising:
an open circle structure that fully encircles and is removably attachable to a rim of an upper circumference of an open paint container, wherein the open circle structure comprises a top side that fully covers the rim and a bottom side having a void configured to engage the rim via an annular snap-fit; and
a tray structure, extending from an edge of the open circle structure and at an incline relative to a plane defined by a top side of the open circle structure, the tray structure having an upper surface comprising ridges to remove excess paint from a paint roller and being open for paint flow into the open paint container at the edge from which it extends from the open circle structure
wherein the annular snap-fit is configured to provide a first torque relative to the edge of the open circle structure sufficient to oppose a second torque represented by the removal of excess paint from the paint roller.

2. The drip-preventing, snap-on paint tray of claim 1, wherein the tray structure is sized for a four-inch industry roller frame.

3. The drip-preventing, snap-on paint tray of claim 1, wherein open circle structure is sized for an industry gallon paint can.

4. The drip-preventing, snap-on paint tray of claim 1, further comprising a support ridge extending from a side of open circle structure and from a bottom surface of the tray structure.

5. The drip-preventing, snap-on paint tray of claim 1, wherein the open circle structure and the tray structure are plastic.

6. A device comprising,
a first portion configured to encircle and removably attach to an upper circumference of an open paint container; and
a second portion, extending from the first portion, configured to remove excess paint from a paint roller,
wherein the first portion comprises an open circle structure having a bottom side, the bottom side comprising a void configured to engage a rim of the upper circumference of the open paint,
wherein the void is configured to engage the rim of the upper circumference of the open paint container via a snap-fit to the rim,
wherein the void is configured to engage the rim of the upper circumference of the open paint container via an annular snap-fit to the rim,
wherein the annular snap-fit is configured to provide a first torque relative to the edge of the open circle structure sufficient to oppose a second torque represented by the removal of excess paint from the paint roller.

7.-9. (canceled)

10. The device of claim 6, wherein the bottom side comprises with one or more cantilevers and wherein the void is configured to engage the rim of the upper circumference of the open paint container via a cantilever snap-fit, via the one or more cantilevers, to the rim.

11. The device of claim 6, wherein the first portion comprises an open circle structure, having a top side, the top side fully covering an upper rim of the upper circumference of the open paint container.

12. The device of claim 6, wherein the second portion comprises a tray having a perimeter, wherein a first extent of the perimeter is walled and wherein a second extent of the perimeter is open, and wherein said second portion extends from said first portion at the second extent of the perimeter.

13. The device of claim 12, wherein the tray defines an upper surface that comprises one or more ridges.

14. The device of claim 6, wherein the first portion comprises an open circle structure having a top side, wherein the second portion comprises a tray inclined relative to a plane defined by the top side of the open circle structure.

15. The device of claim 6, wherein the first portion comprises an open circle structure having a top side, wherein the second portion comprises a tray at an incline relative to a plane defined by the top side of the open circle structure, wherein the tray has a perimeter comprising a first extent of the perimeter and a second extent of the perimeter, wherein the first extent of the perimeter is walled and wherein the second extent of the perimeter is open, wherein said second portion extends from said first portion at the second extent of the perimeter,
such that excess paint, removed from a paint roller in the tray flows down the tray, via the incline, through the second extent of the perimeter, into the open paint container.

16. The device of claim 6, wherein the second portion is sized for a four-inch industry roller frame.

17. The device of claim 6, wherein the first portion is sized for an industry gallon paint can.

18. The device of claim 6, comprising a support ridge extending from a side of first portion and from a bottom surface of second portion.

19. The device of claim 6, wherein the tray structure is sized to avoid a handle of the open paint container.

20. A method of manufacturing comprising:
injection molding a plastic part comprising a first portion and a second portion, wherein the first portion is configured to encircle and removably attach to an upper circumference of an open paint container, wherein the second portion, extending from the first portion, is configured to remove excess paint from a paint roller,
wherein the first portion comprises an open circle structure having a bottom side, the bottom side comprising a void configured to engage a rim of the upper circumference of the open paint,
wherein the void is configured to engage the rim of the upper circumference of the open paint container via a snap-fit to the rim,
wherein the void is configured to engage the rim of the upper circumference of the open paint container via an annular snap-fit to the rim,
wherein the annular snap-fit is configured to provide a first torque relative to the edge of the open circle structure sufficient to oppose a second torque represented by the removal of excess paint from the paint roller.

21. The drip-preventing, snap-on paint tray of claim 1, wherein the bottom side comprises with one or more cantilevers and wherein the void is configured to engage the rim of the upper circumference of the open paint container via a cantilever snap-fit, via the one or more cantilevers, to the rim.

22. The method of claim 20, wherein the bottom side comprises with one or more cantilevers and wherein the void is configured to engage the rim of the upper circumference of the open paint container via a cantilever snap-fit, via the one or more cantilevers, to the rim.
